(19) United States
(12) Patent Application Publication
(10) Pub. No.: US 2013/0288601 A1
(43) Pub. Date: Oct. 31, 2013

(54) AUTOMATIC CONFIGURATION OF ELECTRONIC DEVICES

(71) Applicant: Kapil Chhabra, Milpitas, CA (US)

(72) Inventor: Kapil Chhabra, Milpitas, CA (US)

(73) Assignee: APPLE INC., Cupertino, CA (US)

(21) Appl. No.: 13/456,569

(22) Filed: Apr. 26, 2012

(51) Int. Cl. H04W 84/02

(52) U.S. Cl. 455/41.2

(57) ABSTRACT

The disclosed embodiments provide a system that facilitates the configuration of a first electronic device. During operation, the system detects a non-configured state of the first electronic device in proximity to a second electronic device. Next, the system establishes a network connection between the first and second electronic devices. Finally, the system uses the network connection to transmit configuration information from the second electronic device to the first electronic device, wherein the configuration information is used to configure the first electronic device without receiving manual input from a user through a user interface of the first electronic device.

### BACKGROUND

1. Field

The disclosed embodiments relate to configuration of electronic devices. More specifically, the disclosed embodiments relate to techniques for automatically configuring electronic devices without receiving user input from users through user interfaces of the electronic devices.

2. Related Art

Recent improvements in computing power and wireless networking technology have significantly increased the capabilities of electronic devices. For example, laptop computers, tablet computers, portable media players, smartphones, digital media receivers, video game consoles, and/or other modern computing devices are typically equipped with WiFi capabilities that allow the computing devices to stream audio and/or video, share desktops and/or user interfaces (UIs), and/or transfer files wirelessly among one another.

However, some wireless-enabled electronic devices may lack keyboards, touchscreens, and/or other input devices that allow users to easily provide text input to the electronic devices. Instead, the users may configure and/or operate the computing devices using a limited set of buttons, switches, and/or knobs. For example, a user may configure a digital media receiver by connecting the digital media receiver to a display (e.g., television) and viewing a user interface provided by the digital media receiver on the display. The user may then use a remote control to scroll through a character set in the user interface and select individual characters from the character set to input network credentials for a wireless network to which the digital media receiver should connect, as well as account credentials for user accounts associated with digital media to be accessed using the digital media receiver. Consequently, configuration and/or use of electronic devices with limited I/O capabilities may be tedious, slow, and/or challenging for users of the electronic devices.

### SUMMARY

The disclosed embodiments provide a system that facilitates the configuration of a first electronic device. During operation, the system detects a non-configured state of the first electronic device in proximity to a second electronic device. Next, the system establishes a network connection between the first and second electronic devices. Finally, the system uses the network connection to transmit configuration information from the second electronic device to the first electronic device, wherein the configuration information is used to configure the first electronic device without receiving manual input from a user through a user interface of the first electronic device.

In some embodiments, the configuration information comprises at least one of:
(i) network credentials for a wireless network, wherein the network credentials are used by the first electronic device to connect to the wireless network; and
(ii) account credentials associated with one or more user accounts, wherein the account credentials are used by the first electronic device to access the one or more user accounts.

In some embodiments, the system also obtains the network credentials based on a preferred network list from the second electronic device and the wireless network in proximity to the second electronic device, and obtains the account credentials from one or more applications on the second electronic device.

In some embodiments, the system also obtains at least some of the network credentials and the account credentials based on user input from the user. For example, the user may select network and/or account credentials to be included in the configuration information if more than one set of network and/or account credentials are obtained. Conversely, if some or all of the network and/or account credentials are not available on the second electronic device and/or otherwise not suitable for use in configuring the first electronic device, the missing network and/or account credentials may be supplied by the user through a user interface of the second electronic device.

In some embodiments, detecting the non-configured state of the first electronic device in proximity to the second electronic device includes:
(i) detecting the non-configured state using at least one of a beacon frame from the first electronic device and a probe response frame from the first electronic device if the first electronic device is not connected to a wired network; and
(ii) using a discovery protocol to obtain a message indicating the non-configured state of the first electronic device if the first electronic device is connected to the wired network.

In some embodiments, establishing the network connection between the first and second electronic devices comprises using the second electronic device to connect to an ad hoc network created by the first electronic device if the first electronic device is not connected to the wired network, and using an access point connected to the wired network to establish the network connection between the first and second electronic devices if the first electronic device is connected to the wired network.

In some embodiments, the first electronic device lacks a touch-based keyboard and a physical keyboard. For example, the first electronic device may be a digital media receiver, a digital media player, a television, a video game console, and/or an audio output device. On the other hand, the second electronic device may include a touch-based keyboard and/or a physical keyboard. For example, the second electronic device may be a mobile phone, a tablet computer, a portable media player, a laptop computer, and/or a personal computer.

### BRIEF DESCRIPTION OF THE FIGURES

FIG. 1 shows a schematic of a system in accordance with the disclosed embodiments.

FIG. 2 shows a system for facilitating the configuration of an electronic device in accordance with the disclosed embodiments.

FIG. 3 shows a flowchart illustrating the process of facilitating the configuration of a first electronic device in accordance with the disclosed embodiments.

FIG. 4 shows a flowchart illustrating the process of configuring a first electronic device in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices. When the hardware modules or apparatus are activated, they perform the methods and processes included within them.

The disclosed embodiments provide a method and system for facilitating the configuration of an electronic device with limited input/output (I/O) functionality, such as a digital media receiver, digital media player, television, video game console, and/or audio output device. For example, the electronic device may lack a physical keyboard, a touch-based keyboard, and/or another input mechanism that allows a user to easily provide text input to the electronic device. Instead, the user may input text to the electronic device using a limited set of buttons, knobs, and/or other basic input devices. For example, the user may use a remote control and/or game controller for the electronic device to “type” a word or phrase by scrolling through one or more character sets shown on a display driven by the electronic device and selecting individual characters from the character set(s).

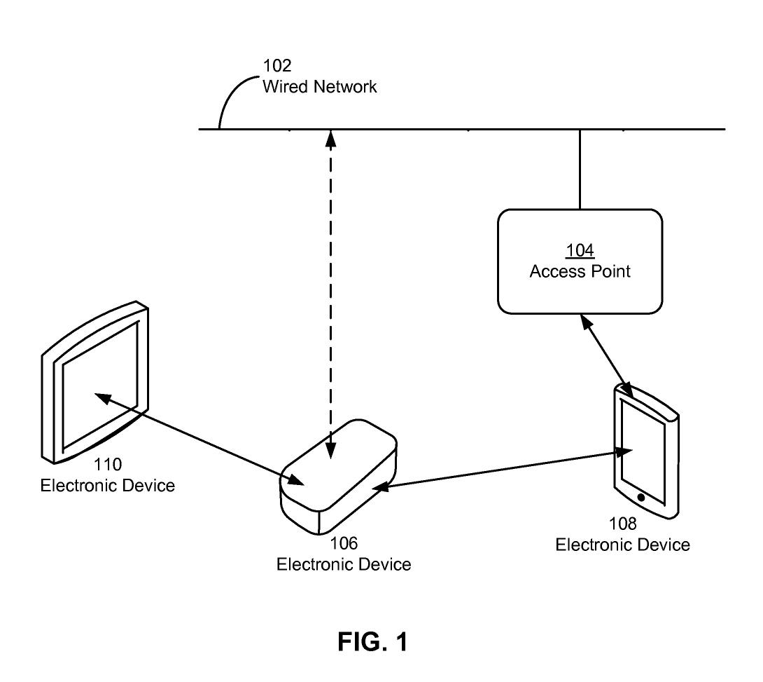

In one or more embodiments, the electronic device includes wired and/or wireless networking functionality. As shown in FIG. 1, an electronic device 106 may be connected to a wired network 102 such as a local area network (LAN), wide area network (WAN), personal area network (PAN), virtual private network, and/or intranet using a wired Ethernet connection. Alternatively, electronic device 106 may wirelessly connect to wired network 102 through an access point 104 connected to wired network 102.

Electronic device 106 may also communicate with one or more other electronic devices 108-110 using wired and/or wireless connections with the other electronic devices. For example, electronic device 106 may be a digital media receiver that drives a display provided by electronic device 110 (e.g., a television) by sending video frames through a cable connecting the two electronic devices. Along the same lines, electronic device 108 may be a tablet computer that displays video frames from electronic device 106 after the video frames are received through a wireless connection with electronic device 106.

Those skilled in the art will appreciate that setup and/or configuration of electronic device 106 may be required to enable the functionality of electronic device 106. For example, electronic device 106 may have network connectivity only after electronic device 106 is connected to wired network 102 using an Ethernet cable and/or network credentials (e.g., network name, password) for a wireless network provided by access point 104 are provided to electronic device 106. Similarly, some or all features of electronic device 106 may not be enabled until account credentials (e.g., usernames, passwords) for user accounts associated with applications on electronic device 106 are obtained by electronic device 106.

As described above, the limited I/O capabilities of electronic device 106 may hinder the prompt and/or efficient configuration of electronic device 106. For example, a user of electronic device 106 may find inputting of multiple names, passwords, and/or other configuration details into electronic device 106 using a remote control, game controller, and/or limited set of buttons to be tedious, complicated, and/or time-consuming.

In one or more embodiments, the networking capabilities of electronic device 106 and/or other electronic devices 108-110 are used to streamline the configuration of electronic device 106. First, electronic device 106 may enable detection of a non-configured state of electronic device 106 in proximity to a second electronic device (e.g., electronic device 108). For example, electronic device 106 may wirelessly transmit a beacon frame and/or probe response frame indicating the non-configured state, or electronic device 106 may advertise the non-configured state using a discovery protocol and wired network 102. Once the non-configured state is detected by the second electronic device, the second electronic device may establish a network connection with electronic device 106. For example, the second electronic device may connect to an ad hoc network created by electronic device 106 if electronic device 106 is not connected to wired network 102. On the other hand, the second electronic device may use an access point (e.g., access point 104) connected to wired network 102 to establish the network connection if electronic device 106 is connected to wired network 102.

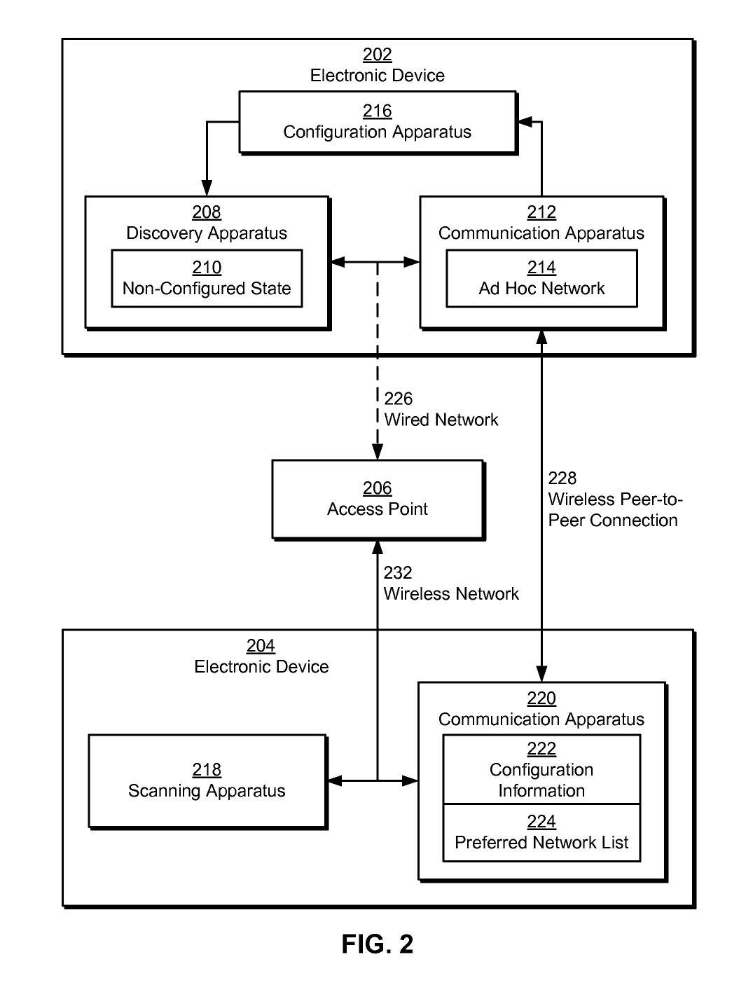

The second electronic device may then use the network connection to transmit configuration information to electronic device 106, and electronic device 106 may use the configuration information to configure electronic device 106 without receiving user input from a user through a user interface of electronic device 106. Automatic configuration of electronic devices using configuration information from other electronic devices is discussed in further detail below with respect to FIG. 2.

FIG. 2 shows a system for facilitating the configuration of an electronic device 202 in accordance with the disclosed embodiments. Like electronic device 106 of FIG. 1, electronic device 202 may lack a touch-based and/or physical keyboard but include wired and/or wireless networking capabilities. For example, electronic device 202 may be a digital media receiver, digital media player, television, video game console, and/or audio output device (e.g., stereo system).

During initial setup of electronic device 202, electronic device 202 may be connected to a power supply (e.g., mains power) using a cable supplied with electronic device 202. Electronic device 202 may also be connected to a display and/or a wired network 226 if cables (e.g., Digital Visual Interface (DVI) cable, High-Definition Multimedia Interface (HDMI) cable, Ethernet cable, etc.) and/or ports for connecting electronic device 202 to the display and/or wired network 226 are available.

Configuration of electronic device 202 may then be performed to enable various features and/or functionality of electronic device 202. For example, configuration information 222 such as network credentials for a wireless network (e.g., wireless network 232) may be provided to electronic device 202 to allow electronic device 202 to connect to the wireless network (e.g., if electronic device 202 is not connected to wired network 226). Configuration information 222 for electronic device 202 may also include account credentials for one or more user accounts to enable access to applications and/or data associated with the user accounts from electronic device 202.

In addition, configuration of electronic device 202 may be performed automatically, during which configuration information 222 is transmitted from a second electronic device 204 (e.g., mobile phone, tablet computer, portable media player, personal computer, etc.) to electronic device 202, or manually, in which a user manually inputs configuration information 222 using input mechanisms associated with electronic device 202. During setup of electronic device 202, the user may be given an option to select either automatic or manual configuration of electronic device 202. For example, the user may be presented with the option through a user interface of electronic device 202 and/or electronic device 204.

Configuration of electronic device 202 may then proceed based on the selected configuration mode (e.g., manual or automatic) from the user and/or the connecting of electronic device 202 to wired network 226. If manual configuration of electronic device 202 is selected by the user, a configuration apparatus 216 on electronic device 202 may obtain configuration information 222 from the user through a user interface of electronic device 202. For example, the user may manually input network and/or account credentials into electronic device 202 by using a remote control, game controller, and/or limited set of buttons to scroll through one or more character sets shown on the user interface and select individual characters from the character set(s). Configuration apparatus 216 may then use the inputted network and/or account credentials to configure electronic device 202.

On the other hand, if automatic configuration of electronic device 202 is selected by the user, a discovery apparatus 208 on electronic device 202 may enable detection of a non-configured state 210 of electronic device 202 in proximity to electronic device 204. For example, if electronic device 202 is not connected to wired network 226, a communication apparatus 212 on electronic device 202 may create an ad hoc network 214 (e.g., an 802.11 independent basic service set (IBSS)), and discovery apparatus 208 may periodically transmit a beacon frame containing information about ad hoc network 214 and non-configured state 210. Discovery apparatus 208 may also transmit a probe response frame containing information about ad hoc network 214 and non-configured state 210 over ad hoc network 214 in response to a probe request frame from electronic device 204. If electronic device 202 is connected to wired network 226, communication apparatus 212 may omit the creation of ad hoc network 214, and discovery apparatus 208 may use a discovery protocol such as Multicast Domain Name System (mDNS) to provide a message indicating non-configured state 210 through wired network 226.

Along the same lines, a scanning apparatus 218 on electronic device 204 may include functionality to detect non-configured state 210. For example, scanning apparatus 218 may be provided by an application on electronic device 204 that enables the configuration of other electronic devices (e.g., electronic device 202) using configuration information 222 stored on electronic device 204. During execution of the application, scanning apparatus 218 may scan the proximity of electronic device 204 for beacon frames that indicate non-configured states (e.g., non-configured state 210) of nearby electronic devices. Alternatively, scanning apparatus 218 may transmit a probe request frame to detect wireless networks (e.g., ad hoc network 214) indicating non-configured states of nearby electronic devices. Finally, scanning apparatus 218 may use the discovery protocol to obtain a message indicating non-configured state 210 from an access point 206 connected to wired network 226. If scanning apparatus 218 detects more than one electronic device with a non-configured state in proximity to electronic device 204, scanning apparatus 218 may obtain a selection of one of the electronic devices for subsequent configuration using configuration information 222 from the user.

Once non-configured state 210 is detected by scanning apparatus 218, a communication apparatus 220 on electronic device 204 may establish a network connection with electronic device 202. As with detection of non-configured state 210, the network connection may be established based on the presence or absence of a connection between electronic device 202 and wired network 226. If electronic device 202 is not connected to wired network 226, electronic device 204 may connect to ad hoc network 214 using information from the beacon frame and/or probe response frame, thus forming a wireless peer-to-peer connection 228 between the two electronic devices 202-204.

If electronic device 202 is connected to wired network 226, electronic device 204 may use an access point (e.g., access point 206) connected to wired network 226 to establish the network connection. For example, electronic device 204 may connect to wireless network 232 provided by access point 206 (e.g., if electronic device 204 is not already connected to wireless network 232) and establish the network connection with electronic device 202 through access point 206. Finally, if electronic device 204 is also connected to wired network 226 (e.g., through an Ethernet cable), electronic device 204 may establish the network connection with electronic device 202 through wired network 226.

Communication apparatus 220 may then transmit configuration information 222 over the network connection to communication apparatus 212. As described above, configuration information 222 may include network credentials (e.g., service set identifier (SSID), password, etc.) for a wireless network (e.g., wireless network 232) and/or account credentials (e.g., username, password, etc.) for one or more user accounts.

The network credentials may allow electronic device 202 to connect to the wireless network. For example, communication apparatus 220 may transmit, to communication apparatus 212, network credentials for a wireless network (e.g., wireless network 232) to which electronic device 204 is already connected. If electronic device 204 is not connected to a wireless network, communication apparatus 220 may compare a preferred network list 224 of wireless networks on electronic device 204 with nearby wireless networks and transmit network credentials for a wireless network (e.g., wireless network 232) that is both within range and in preferred network list 224 to communication apparatus 220. If more than one wireless network is both in proximity to electronic device 204 and in preferred network list 224 (e.g., a list of saved wireless networks previously connected to electronic device 204), communication apparatus 220 may obtain a selection of the wireless network to which electronic device 202 is to be connected from the user. Finally, if electronic device 202 is connected to wired network 226, communication apparatus 220 may omit the network credentials from configuration information 222 because electronic device 202 already has network connectivity through a wired link.

The account credentials may allow electronic device 202 to access the corresponding user account(s) and/or data associated with the user account(s). The account credentials may be stored on electronic device 204 and used by electronic device 204 to access the same user account(s) and/or data. Alternatively, the account credentials may be obtained from the user through a user interface of electronic device 204. For example, the user may enter the account credentials using a physical keyboard and/or touch-based keyboard associated with electronic device 204, thus allowing the user to provide the account credentials more easily and/or efficiently than if the user entered the account credentials using an input mechanism (e.g., remote control, game controller, buttons, etc.) associated with electronic device 202.

Prior to transmitting configuration information 222, communication apparatus 220 may encrypt and/or otherwise secure configuration information 222 to maintain the integrity of configuration information 222. After configuration information 222 is received by communication apparatus 212, configuration apparatus 216 may use configuration information 222 to configure electronic device 202. For example, communication apparatus 212 may decrypt configuration information 222, and configuration apparatus 216 may verify configuration information 222 by displaying one or more identifiers for electronic devices 202-204 and/or network names or usernames from configuration information 222 to the user. Configuration apparatus 216 may then provide the network credentials to communication apparatus 212, and communication apparatus 212 may use the network credentials to connect to wireless network 232. Configuration apparatus 216 may also provide the account credentials to one or more applications on electronic device 202, and the applications may use the account credentials to access the user account(s) and/or associated data. The network and/or account credentials may then be stored in nonvolatile memory on electronic device 202 to enable subsequent use of electronic device 202 with the network and/or account credentials.

Because electronic devices 202-204 may enable detection of non-configured state 210 and transmission of configuration information 222 over different types of network connections, automatic configuration of electronic device 202 may be enabled as long as electronic device 202 is in proximity to electronic device 204. In addition, the verification and/or encryption of configuration information 222 prior to configuring electronic device 202 may ensure that automatic configuration of electronic device 202 is both secured and conducted using the right network and/or account credentials.

Those skilled in the art will appreciate that the system of FIG. 2 may be implemented in a variety of ways. First, components on individual electronic devices 202-204 (e.g., discovery apparatus 208, communication apparatus 212, configuration apparatus 216, scanning apparatus 218, communication apparatus 220) may be provided by the same software and/or hardware component, or the components may execute independently from one another. For example, the components may be implemented by one or more dedicated processors and/or general-purpose processors on electronic devices 202-204.

Second, electronic devices 202-204 may use a number of mechanisms to enable detection of non-configured state 210 and/or establish a network connection with one another. For example, discovery apparatus 208 and scanning apparatus 218 may use a number of discovery protocols and/or 802.11 frames to facilitate the detection of non-configured state 210. Similarly, communication apparatus 212 and communication apparatus 220 may connect to one another through various wired, wireless, and/or ad hoc networking mechanisms.

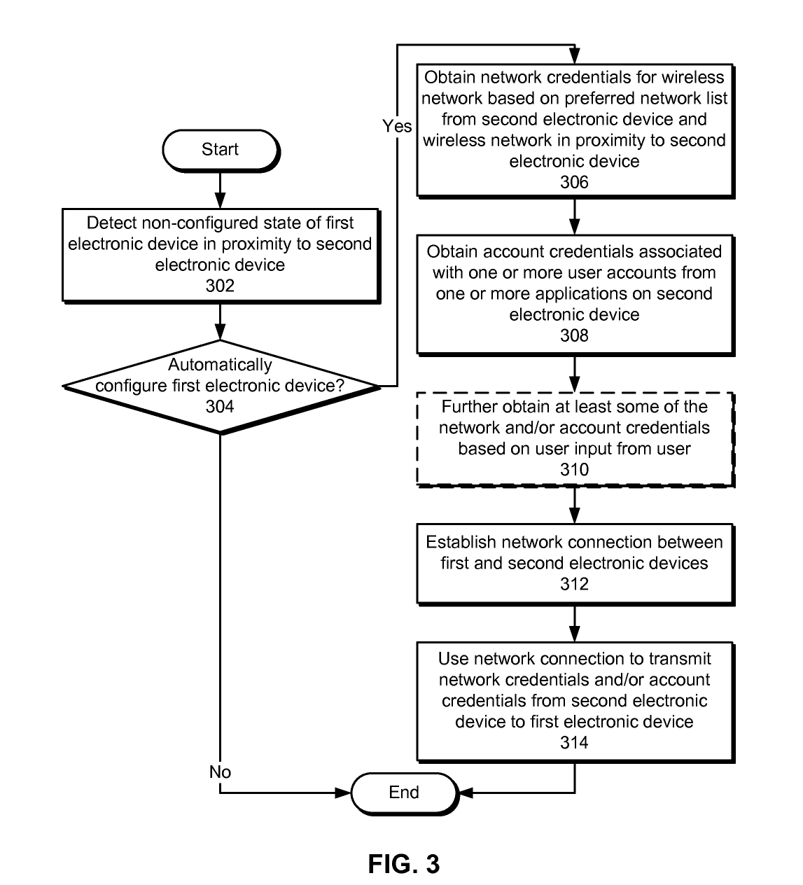

FIG. 3 shows a flowchart illustrating the process of facilitating the configuration of a first electronic device in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, a non-configured state of the first electronic device in proximity to a second electronic device is detected (operation 302). The first electronic device may lack a physical keyboard and/or a touch-based keyboard. For example, the electronic device may be a digital media receiver, a digital media player, a television, a video game console, and/or an audio output device.

The first electronic device may be automatically configured (operation 304) using configuration information from the second electronic device. For example, a user may enable automatic configuration of the first electronic device by selecting an option to automatically configure the first electronic device through a user interface provided by the first and/or second electronic devices. If the first electronic device is not to be automatically configured, the first electronic device may be manually configured by, for example, obtaining configuration information from a user through a user interface of the first electronic device.

If the first electronic device is to be automatically configured, network credentials for a wireless network are obtained based on a preferred network list from the second electronic device and the wireless network in proximity to the second electronic device (operation 306). For example, the network credentials may be obtained from a wireless network in the preferred network list that is also within range of the second electronic device. The network credentials may allow the first electronic device to connect to the wireless network.

Similarly, account credentials associated with one or more user accounts are obtained from one or more applications on the second electronic device (operation 308). The account credentials may allow the first electronic device to access the user account(s) and/or provide features and functionality associated with the user account(s). For example, the account credentials may enable access to documents, streaming media, photos, financial information, and/or games associated with the user account(s).

Some or all of the network and/or account credentials may optionally be obtained based on user input from the user (operation 310). For example, the user may select network and/or account credentials to be used in configuring the first electronic device if more than one set of network and/or account credentials are obtained in operations 306-308. Conversely, if some or all of the network and/or account credentials are not available on the second electronic device and/or otherwise not suitable for use in configuring the first electronic device, the missing network and/or account credentials may be supplied by the user through a user interface of the second electronic device.

Next, a network connection is established between the first and second computing devices (operation 312). For example, the second electronic device may be used to connect to an ad hoc network created by the first electronic device if the first electronic device is not connected to a wired network. On the other hand, an access point connected to the wired network may be used to establish the network connection between the first and second electronic devices if the first electronic device is connected to the wired network.

Finally, the network connection is used to transmit configuration information containing the network credentials and/or account credentials from the second electronic device to the first electronic device (operation 314). The configuration information may then be used to configure the first electronic device without receiving input from the user through the user interface of the first electronic device.

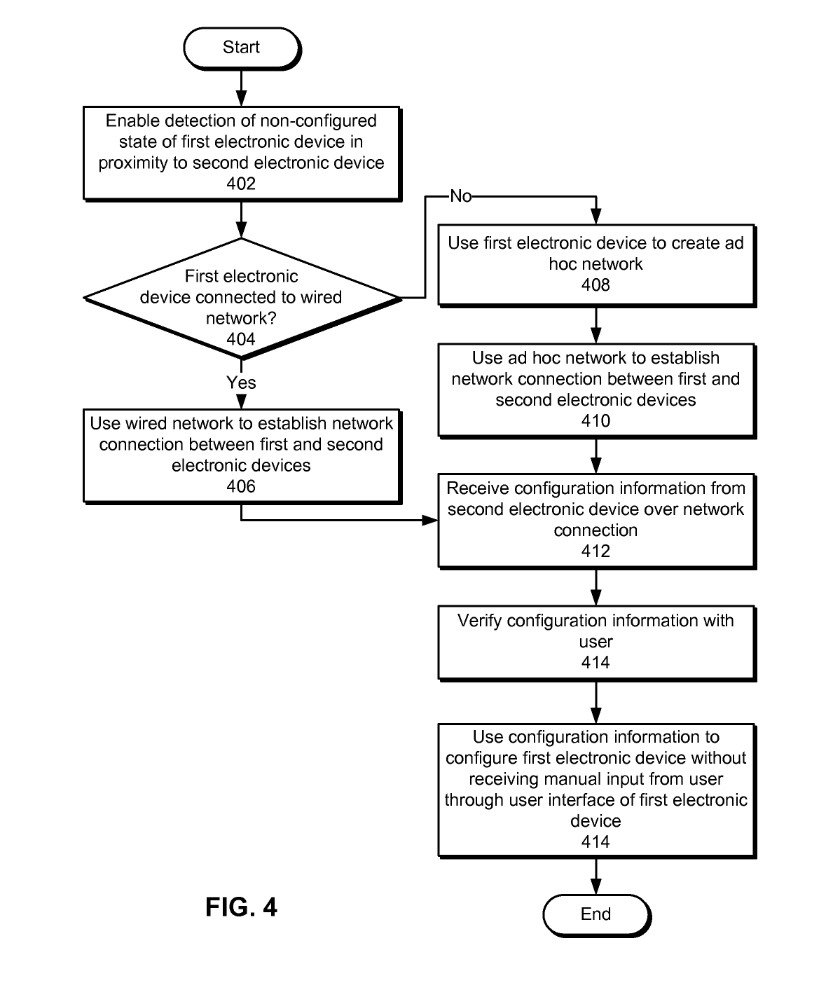

FIG. 4 shows a flowchart illustrating the process of configuring a first electronic device in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

First, detection of a non-configured state of a first electronic device in proximity to a second electronic device is enabled (operation 402). Detection of the non-configured state may be enabled by transmitting a beacon frame from the first electronic device, transmitting a probe response frame from the first electronic device in response to a probe request frame from the second electronic device, and/or using a discovery protocol to provide a message indicating the non-configured state of the first electronic device.

Configuration of the first electronic device may proceed based on a connection of the first electronic device to a wired network (operation 404). If the first electronic device is connected to the wired network, the wired network is used to establish a network connection between the first and second electronic devices (operation 406). For example, the second electronic device may connect to the first electronic device through an access point of the wired network.

If the first electronic device is not connected to the wired network, the first electronic device is used to create an ad hoc network (operation 408), and the ad hoc network is used to establish the network connection (operation 410). For example, the second electronic device may establish the network connection by connecting to the ad hoc network. The ad hoc network may additionally be created to enable the transmission of beacon frames and/or probe response frames from the first electronic device to the second electronic device.

After the network connection is established, configuration information from the second electronic device is received over the network connection (operation 412). The configuration information may include network credentials (e.g., SSID, password, etc.) for a wireless network and/or account credentials (e.g., username, password, etc.) associated with one or more user accounts. The configuration information may also be verified with a user (operation 414). For example, the network name and/or usernames from the configuration information may be displayed to the user to verify that the first electronic device will be correctly configured. Alternatively, an identifier associated with the second electronic device may be displayed to the user to verify the source of the configuration information.

If verification of the configuration information is successful, the configuration information is used to configure the first electronic device without receiving manual input from the user through the user interface of the first electronic device (operation 414). For example, the network credentials may be used by the first electronic device to connect to the wireless network, and the account credentials may be used by the first electronic device to access the user account(s) and/or data associated with the account credentials. Such configuration of the first electronic device may also be performed without requiring the user to input text using a remote control, game controller, and/or other limited input mechanism for the electronic device.

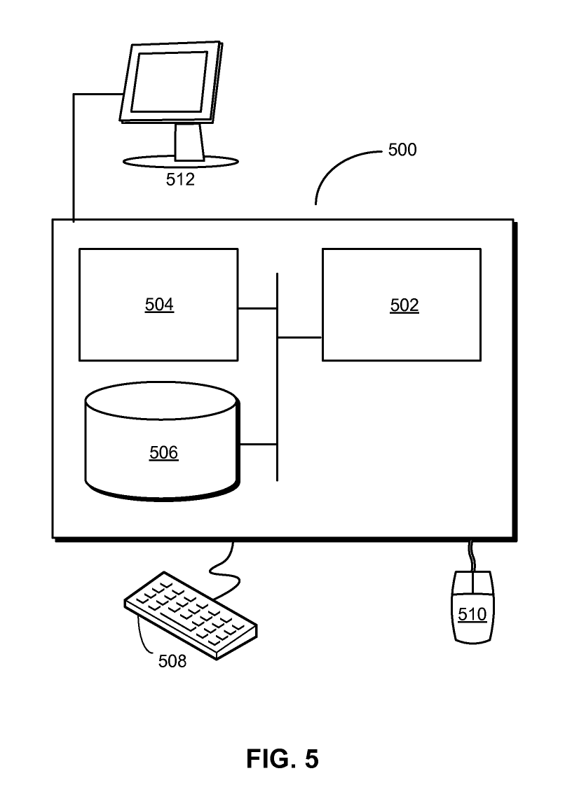

FIG. 5 shows a computer system 500 in accordance with the disclosed embodiments. Computer system 500 may correspond to an apparatus that includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for facilitating the configuration of a first electronic device. The system may provide a second electronic device that detects the non-configured state of the first electronic device. Next, the second electronic device may establish a network connection with the first electronic device. Finally, the second electronic device may use the network connection to transmit the configuration information to the first electronic device, and the configuration information may be used to configure the first electronic device without receiving manual input from a user through a user interface of the first electronic device.

In addition, one or more components of computer system 500 may be remotely located and connected to the other components over a network. Portions of the present embodiments (e.g., discovery apparatus, communication apparatus, configuration apparatus, electronic devices, etc.) may also be located on different nodes of a distributed system that implements the embodiments. For example, the present embodiments may be implemented using a number of electronic devices connected through a set of wired, wireless, and/or ad hoc (e.g., peer to peer) network connections with one another.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method for facilitating the configuration of a first electronic device, comprising:
detecting a non-configured state of the first electronic device in proximity to a second electronic device;
establishing a network connection between the first and second electronic devices; and
using the network connection to transmit configuration information from the second electronic device to the first electronic device, wherein the configuration information is used to configure the first electronic device without receiving manual input from a user through a user interface of the first electronic device.

2. The method of claim 1, wherein the configuration information comprises at least one of:
network credentials for a wireless network, wherein the network credentials are used by the first electronic device to connect to the wireless network; and
account credentials associated with one or more user accounts, wherein the account credentials are used by the first electronic device to access the one or more user accounts.

3. The method of claim 2, further comprising:
obtaining the network credentials based on a preferred network list from the second electronic device and the wireless network in proximity to the second electronic device; and
obtaining the account credentials from one or more applications on the second electronic device.

4. The method of claim 3, further comprising:
further obtaining at least some of the network credentials and the account credentials based on user input from the user.

5. The method of claim 1, wherein detecting the non-configured state of the first electronic device in proximity to the second electronic device comprises:
if the first electronic device is not connected to a wired network, detecting the non-configured state using at least one of:
a beacon frame from the first electronic device; and
a probe response frame from the first electronic device; and
if the first electronic device is connected to the wired network, using a discovery protocol to obtain a message indicating the non-configured state of the first electronic device.

6. The method of claim 1, wherein establishing the network connection between the first and second electronic devices comprises:
if the first electronic device is not connected to the wired network, using the second electronic device to connect to an ad hoc network created by the first electronic device; and
if the first electronic device is connected to the wired network, using an access point connected to the wired network to establish the network connection between the first and second electronic devices.

7. The method of claim 1, wherein the first electronic device lacks a touch-based keyboard and a physical keyboard.

8. A method for configuring a first electronic device, comprising:
enabling detection of a non-configured state of the first electronic device in proximity to a second electronic device;
receiving configuration information from the second electronic device over a network connection between the first and second electronic devices; and
using the configuration information to configure the first electronic device without receiving manual input from a user through a user interface of the first electronic device.

9. The method of claim 8, further comprising:
if the first electronic device is not connected to a wired network:
using the first electronic device to create an ad hoc network; and
using the ad hoc network to establish the network connection; and
if the first electronic device is connected to the wired network, using the wired network to establish the network connection.

10. The method of claim 8, wherein enabling detection of the non-configured state of the first electronic device in proximity to the second electronic device comprises at least one of:
transmitting a beacon frame from the first electronic device;
transmitting a probe response frame from the first electronic device in response to a probe request frame from the second electronic device; and
using a discovery protocol to provide a message indicating the non-configured state of the first electronic device.

11. The method of claim 8, further comprising:
verifying the configuration information with the user prior to configuring the first electronic device.

12. The method of claim 8, wherein the configuration information comprises at least one of:
network credentials for a wireless network, wherein the network credentials are used by the first electronic device to connect to the wireless network; and
account credentials associated with one or more user accounts, wherein the account credentials are used by the first electronic device to access the one or more user accounts.

13. A system for facilitating the configuration of a first electronic device, comprising:
the first electronic device configured to:
enable detection of a non-configured state of the first electronic device; and
use configuration information from a second electronic device to configure the first electronic device without receiving manual input from a user through a user interface of the first electronic device; and
the second electronic device configured to:
detect the non-configured state of the first electronic device;
establish a network connection between the first and second electronic devices; and
use the network connection to transmit the configuration information to the first electronic device.

14. The system of claim 13, wherein the configuration information comprises at least one of:
network credentials for a wireless network, wherein the network credentials are used by the first electronic device to connect to the wireless network; and
account credentials associated with one or more user accounts, wherein the account credentials are used by the first electronic device to access the one or more user accounts.

15. The system of claim 14, wherein the second electronic device is further configured to:
obtain the network credentials based on a preferred network list on the second electronic device and the wireless network in proximity to the second electronic device; and
obtain the account credentials from one or more applications on the second electronic device.

16. The system of claim 13, wherein the second electronic device is configured to detect the non-configured state using at least one of:
a beacon frame from the first electronic device;
a probe response frame from the first electronic device; and
a message from a discovery protocol indicating the non-configured state of the first electronic device.

17. The system of claim 13, wherein the first electronic device is further configured to:
create an ad hoc network if the first electronic device is not connected to a wired network.

18. The system of claim 17, wherein establishing the network connection between the first and second electronic devices comprises:
if the first electronic device is not connected to the wired network, using the second electronic device to connect to the ad hoc network; and
if the first electronic device is connected to the wired network, using an access point connected to the wired network to establish the network connection between the first and second electronic devices.

19. The system of claim 13, wherein the first electronic device is at least one of a digital media receiver, a digital media player, a television, a video game console, and an audio output device.

20. The system of claim 13, wherein the second electronic device is at least one of a mobile phone, a tablet computer, a portable media player, a laptop computer, and a personal computer.

21. A computer-readable storage medium storing instructions that when executed by a computer cause the computer to perform a method for facilitating the configuration of a first electronic device that lacks a keyboard, the method comprising:
detecting a non-configured state of the first electronic device in proximity to a second electronic device;
establishing a network connection between the first and second electronic devices; and
using the network connection to transmit configuration information from the second electronic device to the first electronic device, wherein the configuration information is used to configure the first electronic device without receiving manual input from a user through a user interface of the first electronic device.

22. The computer-readable storage medium of claim 21, wherein the configuration information comprises at least one of:
network credentials for a wireless network, wherein the network credentials are used by the first electronic device to connect to the wireless network; and
account credentials associated with one or more user accounts, wherein the account credentials are used by the first electronic device to access the one or more user accounts.

23. The computer-readable storage medium of claim 22, the method further comprising:
obtaining the network credentials based on a preferred network list from the second electronic device and the wireless network in proximity to the second electronic device; and
obtaining the account credentials from one or more applications on the second electronic device.

24. The computer-readable storage medium of claim 21, wherein detecting the non-configured state of the first electronic device in proximity to the second electronic device comprises:
if the first electronic device is not connected to a wired network, detecting the non-configured state using at least one of:
a beacon frame from the first electronic device; and
a probe response frame from the first electronic device; and
if the first electronic device is connected to the wired network, using a discovery protocol to obtain a message indicating the non-configured state of the first electronic device.

25. The computer-readable storage medium of claim 21, wherein establishing the network connection between the first and second electronic devices comprises:
if the first electronic device is not connected to the wired network, using the second electronic device to connect to an ad hoc network created by the first electronic device; and
if the first electronic device is connected to the wired network, using an access point connected to the wired network to establish the network connection between the first and second electronic devices.
